(19) United States
(12) Patent Application Publication
(10) Pub. No.: US 2008/0107219 A1
(43) Pub. Date: May 8, 2008

(54) Electronic articles surveillance system synchronization using global positioning satellite signal

(75) Inventors: Jeffrey T. Oakes, Boca Raton, FL (US); Thomas J. Frederick, Chapel Hill, NC (US); Gerry Aguirre, Pompano Beach, FL (US)

Correspondence Address: CHRISTOPHER & WEISBERG, P.A., 200 EAST LAS OLAS BOULEVARD, SUITE 2040, FORT LAUDERDALE, FL, 33301, US

(73) Assignee: Sensormatic Electronics Corporation

(21) Appl. No.: 11/729,372

(22) Filed: Mar. 28, 2007

Related U.S. Application Data
(60) Provisional application No. 60/857,374, filed on Nov. 7, 2006.

(51) Int. Cl. H04L 7/00

(52) U.S. Cl. 375/356

(57) ABSTRACT

A method and system for synchronizing the operation of a plurality of electronic article surveillance (“EAS”) units that includes receiving a global positioning satellite reference signal, generating a synchronization master signal using the global positioning satellite reference signal and transmitting the master synchronization signal to the plurality of EAS units. The method and system can further include a secondary synchronization master, which is configurable to relay the master synchronization signal.

### CROSS-REFERENCE TO RELATED APPLICATION

This application is related to and claims priority to U.S. Provisional Patent Application Ser. No. 60/857,374, filed Nov. 7, 2006, entitled ELECTRONIC ARTICLE SURVEILLANCE SYSTEM SYNCHRONIZATION USING GLOBAL POSITIONING SATELLITE SIGNAL, the entirety of which is incorporated herein by reference.

### STATEMENT REGARDING FEDERALLY SPONSORED RESEARCH OR DEVELOPMENT

n/a

### FIELD OF THE INVENTION

The present invention relates to electronic article surveillance (“EAS”) systems, and more particularly to the synchronization of multiple EAS systems.

### BACKGROUND OF THE INVENTION

Electronic Article Surveillance (“EAS”) systems are detection systems that allow the detection of a marker or tag within a given detection region. EAS systems have many uses, but most often they are used as security systems to prevent shoplifting from stores or removal of property from office buildings. EAS systems come in many different forms and make use of a number of different technologies.

A typical EAS system includes an electronic detection EAS unit, markers and/or tags, and a detacher or deactivator. The detection unit includes transmitter and receiver antennas and is used to detect any active markers or tags brought within the range of the detection unit. The antenna portions of the detection units can, for example, be bolted to floors as pedestals, buried under floors, mounted on walls, or hung from ceilings. The detection units are usually placed in high traffic areas, such as entrances and exits of stores or office buildings. The deactivators transmit signals used to detect and/or deactivate the tags.

The markers and/or tags have special characteristics and are specifically designed to be affixed to or embedded in merchandise or other objects sought to be protected. When an active marker passes through the detection unit, the alarm is sounded, a light is activated, and/or some other suitable control devices are set into operation indicating the removal of the marker from the proscribed detection region covered by the detection unit.

Most EAS systems operate using the same general principles. The detection unit includes one or more transmitters and receivers. The transmitter sends a signal at defined frequencies across the detection region. For example, in a retail store, placing the transmitter and receiver on opposite sides of a checkout aisle or an exit usually forms the detection region. When a marker enters the region, it creates a disturbance to the signal being sent by the transmitter. For example, the marker may alter the signal sent by the transmitter by using a simple semiconductor junction, a tuned circuit composed of an inductor and capacitor, soft magnetic strips or wires, or vibrating resonators. The marker may also alter the signal by repeating the signal for a period of time after the transmitter terminates the signal transmission. This disturbance caused by the marker is subsequently detected by the receiver through the receipt of a signal having an expected frequency, the receipt of a signal at an expected time, or both. As an alternative to the basic design described above, the receiver and transmitter units, including their respective antennas, can be mounted in a single housing.

One key concern with EAS systems from a design standpoint is ensuring that there is proper synchronization as between all transmitters and receivers within range of each other. For example, in many systems it is highly important that the transmitter window, during which time the transmitter transmits a marker excitation signal, does not overlap with the receiver window, during which the receiver is attempting to detect a marker response signal. In these systems, any overlap between these two windows will result in degradation of system performance. Sometimes, these two windows are separated by an off state during which neither the receiver nor the transmitter is active. Similarly, the operation of the deactivators can degrade system performance if their transmissions are not synchronized with the operation of the other transmitters and receivers.

Certain conventional EAS systems rely on a local power line current or voltage zero crossing for synchronization of the transmitter window and the receiver window. If there is no other EAS system in close proximity, then the actual position of transmit and receive windows versus the power line zero crossing is not very important. On the other hand, when more than one such system is installed at a distance which allows the receiver of one system to receive a transmitter signal of another system, the relative temporal position of transmit and receive windows in all systems becomes very important. Such a situation may occur for example when there are multiple exits that require separate EAS systems. If the power line zero crossings for all of the EAS systems happen at the same time, then the transmit and receive windows of all of the EAS systems will be synchronized relative to one another. In that case, all windows are perfectly aligned, and there is virtually no possibility that the transmitter pulse of one system will be seen in the receiver of another system. More often however, the various EAS systems are connected to different power line outlets, each having a unique power line phase shift related to the type of load on the power line. This phase shift can vary over time and cause the transmit and receive windows of the various EAS systems to overlap, resulting in degraded performance or false alarming.

Since the local AC power line signal is prone to inaccuracy, due to varying loads on the line that affect phase shift and since some systems may run off generators or be wired 180 degrees out of phase, the prior EAS systems that use proprietary wireless synchronization or wired synchronization between controllers fail to solve the interference problem at a reasonable cost. The current wired synchronization systems remain impractical over moderate to long distances. The current wireless synchronization systems have a high per unit receiver cost and require proprietary transmitters and, many times, proprietary repeaters to be installed.

There exists, therefore, a need for systems and techniques that will provide for low cost, high performance wireless synchronization among EAS controllers.

### SUMMARY OF THE INVENTION

The present invention advantageously provides a method and system for synchronizing the operation of a plurality of electronic article surveillance (“EAS”) units. The method and system can further include a secondary synchronization master, which is configurable to relay the master synchronization signal using, for example, wireless signals.

In accordance with one aspect, the present invention provides a method for synchronizing the operation of a plurality of EAS units. A global positioning satellite reference signal is received. A master synchronization signal is generated using the global positioning satellite reference signal. The synchronization master signal is transmitted to the plurality of EAS systems. The method can further include using a secondary synchronization master to relay the master synchronization signal.

In accordance with another aspect, the present invention provides a system for synchronizing the operation of a plurality of EAS units that includes a synchronization master having a global positioning satellite receiver to receive a global positioning satellite reference signal, a master phase-locked loop to generate a master synchronization signal and a master radio transmitter to transmit the master synchronization signal. The system for synchronizing the operation of a plurality of EAS units can also include a plurality of synchronization receivers configurable to receive the master synchronization signal from the synchronization master.

In accordance with yet another aspect, the present invention provides an EAS system having a synchronization receiver and an EAS unit in communication with the synchronization receiver. The synchronization receiver receives a synchronization signal corresponding to a global positioning satellite reference signal and generates a CPU clock signal based on the received synchronization signal. The EAS unit is arranged to interrogate an EAS marker by transmitting interrogation signals. The EAS unit receives the CPU clock signal and synchronizes the interrogation signals to the CPU clock.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram of a system constructed in accordance with the principles of the present invention;

FIG. 2 is a detailed block diagram of an EAS system constructed in accordance with the present invention;

FIG. 3A is a timing diagram of a synchronization signal from a GPS satellite;

FIG. 3B is a timing diagram of a synchronization signal from a wireless master transmitter;

FIG. 3C is a timing diagram of an interrogation signal from an EAS unit;

FIG. 3D is a timing diagram of a synchronization signal from a wireless secondary master transmitter; and

FIG. 3E is a timing diagram of an interrogation signal from an EAS unit locked to the wireless secondary master.

### DETAILED DESCRIPTION OF THE INVENTION

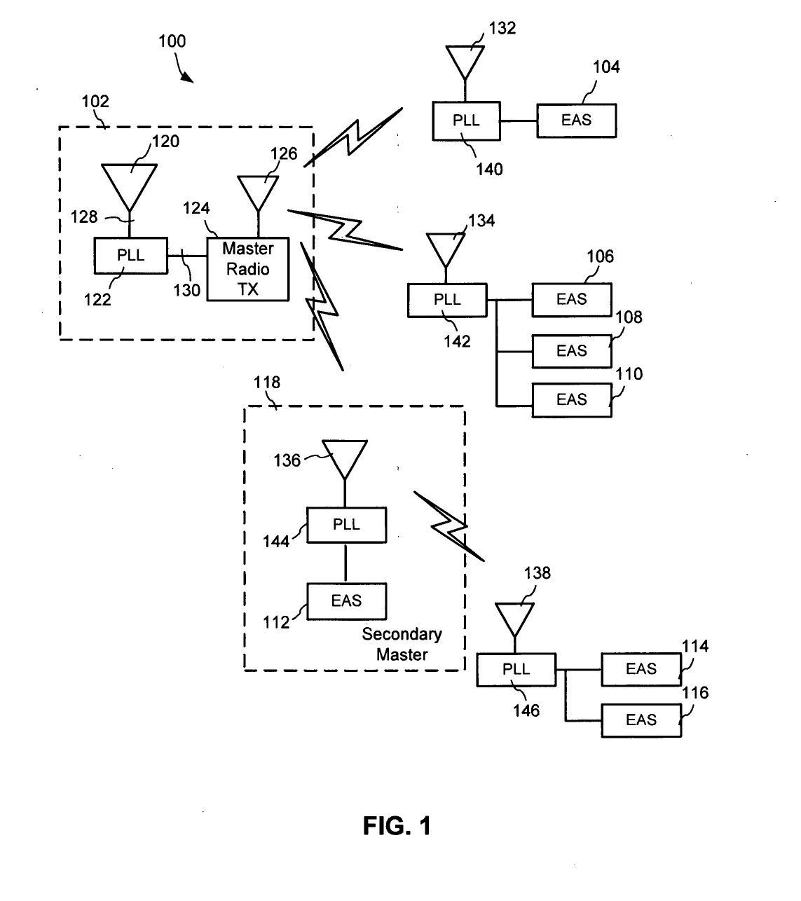

Referring now to the drawing figures in which like reference designators refer to like elements, there is shown in FIG. 1 a diagram of an exemplary system constructed in accordance with the principles of the present invention and designated generally as “100”. System 100 includes a wireless synchronization master 102 and a plurality of electronic article surveillance (“EAS”) units 104, 106, 108, 110, 112, 114 and 116 constructed in accordance with the teachings of the present invention as discussed further below. EAS units 104, 106, 108, 110, 112, 114 and 116 are each deployed at an appropriate location in various installation zones, such as retail stores, inventory warehouses, buildings for which security is to be provided, or the like. Each of the EAS units 104, 106, 108, 110, 112, 114 and 116 are in communication with the wireless synchronization master 102. Of note, although seven EAS units are shown in FIG. 1, this quantity is merely exemplary, it being understood that fewer or more units can be synchronized in accordance with the principles of the present invention.

The wireless synchronization master 102 includes circuitry for generating a wireless synchronization signal from a global positioning satellite (“GPS”) radio frequency (“RF”) signal for transmission to the plurality of EAS units 104, 106, 108, 110, 112, 114 and 116 either directly or via a secondary synchronization master module 118. The wireless synchronization master 102 includes a GPS antenna 120, a phase-locked loop (“PLL”) module 122, a master RF transmitter 124 and a wireless antenna 126. The GPS antenna 120 receives a 1 Hz RF reference signal 128 from a GPS satellite, which is passed to the PLL module 122 for synchronization. Of note, although FIG. 1 does not show an EAS unit coupled to synchronization master 102, is it understood that one or mode EAS units can be coupled to and supported by master 102. EAS units are not shown coupled to master 102 in FIG. 1 solely for ease of understanding.

In general, a phase-locked loop (“PLL”) is a feedback control circuit that synchronizes the phase of a generated signal with that of a reference signal. The function of a PLL is to lock a frequency desired in the system to an accurate reference frequency. In system 100, the master PLL 122 is synchronized to the GPS reference signal 128 and generates a 60 Hz synchronization signal 130 that is transmitted, via master RF transmitter 124, to receivers 132, 134, 136 and 138. The wireless synchronization master 102 can transmit the 60 Hz synchronization signal 130 by various communication link protocols, including, for example ZigBee, which is the name of a specification for a suite of high level communication protocols using small, low-power digital radios based on the IEEE 802.15.4 standard for wireless personal area networks (“WPANs”). After receipt of the master PLL 122 synchronization signal 130, the receiver devices 132, 134, 136 and 138 are phase-locked to the master PLL 122 and supply a 60 Hz synchronization signal 130 to the EAS units 104, 106, 108, 110, 112, 114 and 116. Accordingly, this system can be used for setting burst level synchronization of the EAS units across very broad geographical regions, regardless of power grid frequency, phase drift or quality.

The synchronization signal recovery PLLs 140, 142, 144 and 146, referred to collectively herein as “signal recovery PLLs”, allow recovery of the 60 Hz synchronization signal transmitted by the synchronization master. In the present embodiment, receivers such as receiver 132, and their corresponding PLL, such as PLL 140, are shown as separate from the EAS unit 104; however, the receiver and the PLL can be integrated with the EAS unit 104 as well. By providing a PLL at each EAS receiver, system 100 allows carrier level synchronization with the EAS synchronization signal transmitter 124. This advantageously allows disjoint systems to act together in covering one or more interrogation regions without creating major interference or noise generation.

The system 100 can also include a wireless secondary synchronization master 118, which is a designated receiver that can detect the signal transmitted by the synchronization master 102 and is configured to transmit synchronization signals to other EAS units, such as EAS 114 and 116 that are unable to detect the signal from synchronization master 102 because they might be shielded or simply too distant from the synchronization master 102. The secondary synchronization master 118 includes hardware to phase-lock to the 60 Hz signal transmitted by the synchronization master 102 and transmit or relay the 60 Hz synchronization signal 130, with a delay, e.g., of 1/90 Hz or 1/180 Hz or other multiple of 1/90 Hz, from the synchronization master 102 to those EAS units that can not receive the synchronization signal from the synchronization master.

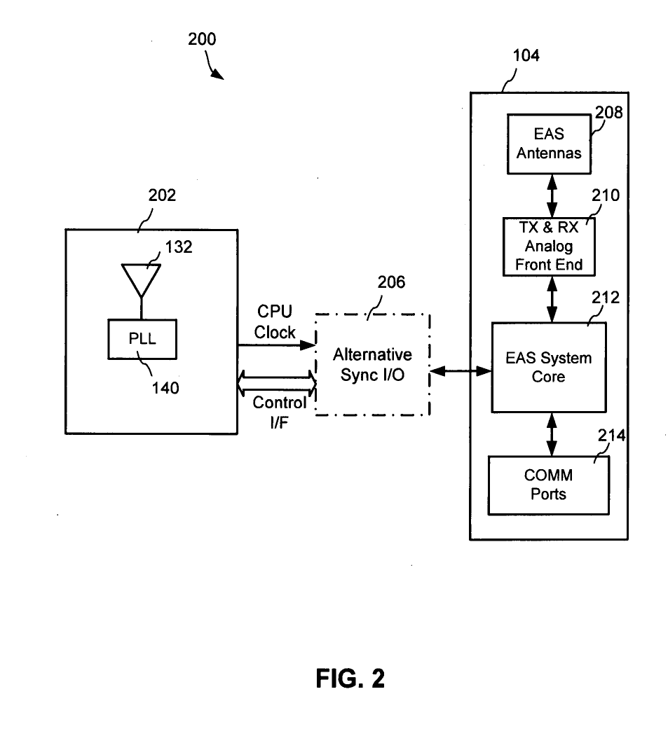

FIG. 2 is a detailed block diagram of a system 200 constructed in accordance with the present invention. The system 200 includes synchronization receiver module 202, EAS unit 104 and an optional alternative synchronization input/output interface 206. In this embodiment, the EAS unit 104 includes antennas 208, a transmit/receive analog front end 210, a system control core 212 and communication ports 214. The antennas 208 are coupled to the transmit/receive analog front end 210 and provide for transmitting the burst or exciter pulse and receiving a characteristic response of an excited marker or tag. The system control core 212 controls the timing of the transmit and receive windows, as well as accepts a CPU clock signal from synchronization receiver module 202, which provides for synchronization of transmit and receive windows of one or more EAS units 104. The exchange of the CPU clock and control I/F signals can be facilitated by an optional alternative synchronization input/output interface 206 or directly exchanged by the EAS unit 104 and synchronization receiver module 202.

Additionally, the exchange of the CPU clock and control I/F signals between synchronization receiver module 202 and EAS unit 104 can be by a wired or wireless communication link. Alternatively, as previously discussion with respect to system 100 of FIG. 1, the functions of the synchronization receiver module 202, which includes the receiver 132 and the PLL 140, can be integrated with the EAS unit 104. It should be noted that the system 200 illustrated in FIG. 2 is an exemplary system 100 that is used in a typical EAS interrogation system of the present invention and the invention disclosed herein is not limited to a particular design or type of system 200.

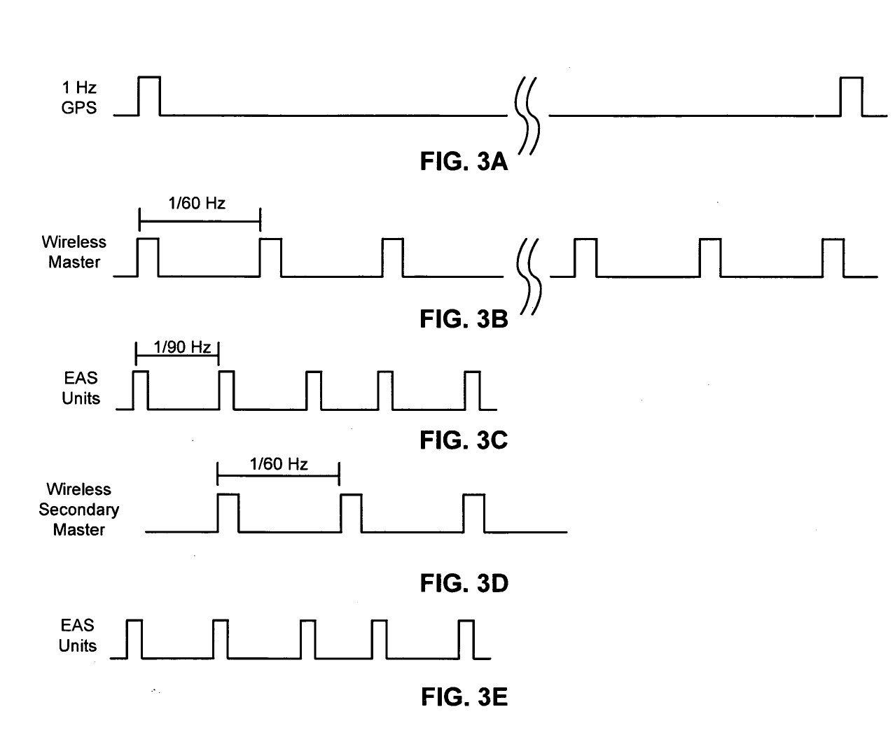

FIGS. 3A-3E are timing diagrams illustrating the synchronization and burst signals of system 100 of FIG. 1 during operation. FIG. 3A illustrates a 1 Hz RF reference signal received from a global positioning satellite system by wireless synchronization master 102. FIG. 3B illustrates a 60 Hz synchronization signal generated and transmitted by wireless synchronization master 102 and received by the plurality of EAS units 104, 106, 108, 110, 112, 114 and 116 via receiver devices 132, 134, 136 and 138 using a communication link protocol, which employs small, low-power digital radios based on the IEEE 802.15.4 standard for wireless personal area networks (“WPANs”). FIG. 3C illustrates that wireless receiver devices 132, 134, 136 and 138 are phase locked to the wireless synchronization master 102 and are supplying a 60 Hz synchronization signal to the EAS units 104, 106, 108, 110, 112, 114 and 116, which the EAS units 104, 106, 108, 110, 112, 114 and 116 use to synchronize the interrogation burst signal at a frequency of 90 Hz.

FIG. 3D illustrates the use of a designated receiver module (identified as wireless secondary synchronization master module 118) that is in communication with the wireless synchronization master 102 and is configured to transmit a synchronization signal that is phase locked to the wireless synchronization master 102 to various other wireless receiver modules that do not “hear” the wireless synchronization master 102. Although there is a slight delay in time before the wireless secondary synchronization master module 118 transmits the synchronization signal 130 generated by the wireless synchronization master 102, e.g., a delay of 1/90 Hz or 1/180 Hz, to the out of range EAS units, these out of range EAS units are phase-locked to the wireless secondary synchronization master 118 and can transmit their respective interrogation burst signals at the same time as the EAS units that can receive signals from the wireless synchronization master 102 and thereby reduce interference and noise generation among the various EAS units.

The transmission from deactivators (not shown) in the system can be synchronized with the various EAS units in the same manner as described above so as not to degrade system performance. It is understood that deactivators can be implemented and coupled within the system any place an EAS unit can be implemented. In other words, for purposes of the present invention, EAS units shown in the drawing figures can be deactivators. Of note, although the present invention is described with reference to a 60 Hz system, it is understood that the present invention can be implemented using another base frequency, e.g., 50 Hz.

The present invention advantageously provides and defines a comprehensive system and method for implementing a wireless synchronization of transmit and receive signals across EAS units using a remote reference source such as a GPS reference signal. The present invention further advantageously provides and defines a comprehensive system and method for implementing a wireless synchronization of transmit and receive signals across EAS units using synchronization receiver modules having PLLs. Furthermore, the use of PLLs with the receiver devices provides for continuous system operation in the event of an interrupted GPS reference signal 128.

Of note, it is contemplated that the present invention, and in particular the communication components and aspects of the present invention, can be used to provide data communication between the EAS units during idle periods of the synchronization signal transmission.

The present invention can be realized in hardware, software, or a combination of hardware and software. Any kind of computing system, or other apparatus adapted for carrying out the methods described herein, is suited to perform the functions described herein.

A typical combination of hardware and software could be a specialized or general-purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method for synchronizing the operation of a plurality of electronic article surveillance (“EAS”) units, the method comprising:
receiving a global positioning satellite reference signal;
generating a master synchronization signal using the global positioning satellite reference signal; and
transmitting the master synchronization signal to a plurality of EAS units.

2. The method of claim 1, further comprising receiving the master synchronization signal at a synchronization receiver.

3. The method of claim 2, further comprising generating a central processing unit clock signal based on the master synchronization signal and transmitting the central processing unit clock signal to an EAS controller.

4. The method of claim 3, wherein the central processing unit clock signal is wirelessly transmitted.

5. The method of claim 1, further comprising using a wireless secondary synchronization master to relay the master synchronization signal.

6. The method of claim 5, further comprising delaying the relay of the master synchronization signal by a delay period.

7. The method of claim 6, wherein the delay period is a multiple of 1/90 Hz.

8. A system for synchronizing the operation of a plurality of EAS units, the system comprising:
a synchronization master, the synchronization master including:
a global positioning satellite receiver to receive a global positioning satellite reference signal;
a master phase-locked loop to generate a master synchronization signal; and
a master radio transmitter to transmit the master synchronization signal.

9. The system of claim 8, further comprising a plurality of synchronization receivers, at least one of the plurality of synchronization receivers receiving the master synchronization signal from the synchronization master.

10. The system of claim 9, wherein the at least one of the plurality of synchronization receivers includes a synchronization phase-locked loop to generate a central processing unit clock signal from the master synchronization signal, the at least one of the plurality of synchronization receivers transmitting the central processing unit clock signal to an EAS controller.

11. The system of claim 9, wherein the at least one of the plurality of synchronization receivers transmits the synchronization master signal to an EAS controller of at least one of the plurality of EAS units.

12. The system of claim 11, wherein the at least one of the plurality of synchronization receivers transmits the synchronization master signal to an EAS controller of at least one of the plurality of EAS units using a wireless communication link.

13. The system of claim 11, wherein the at least one of the plurality of synchronization receivers transmits the synchronization master signal to an EAS controller of at least one of the plurality of EAS units using a wired communication link.

14. The system of claim 8, further including a secondary synchronization master, the secondary synchronization master relaying the master synchronization signal to at least one additional synchronization receiver.

15. The system of claim 14, wherein the secondary synchronization master includes a secondary master phase-locked loop for synchronizing to the master synchronization signal.

16. The system of claim 15, wherein the secondary synchronization master transmits the master synchronization signal to the at least one additional synchronization receiver out of communication range with the synchronization master.

17. An EAS system, the EAS system comprising:
synchronization receiver module, the synchronization receiver receiving a synchronization signal corresponding to a global positioning satellite reference signal and generating a CPU clock signal based on the received synchronization signal; and
an EAS unit in communication with the synchronization receiver module, the EAS unit arranged to interrogate an EAS marker by transmitting interrogation signals, the EAS unit receiving the CPU clock signal and synchronizing the interrogation signals to the CPU clock.

18. The system of claim 17, wherein the synchronization receiver module further includes a signal recovery phase-locked loop, the signal recovery phase-locked loop being used to generate the CPU clock signal.

19. The system of claim 17, wherein the EAS system is a secondary master, wherein the secondary master relays the synchronization signal to additional EAS systems.

20. The system of claim 19, wherein the secondary master relays the synchronization signal to additional EAS systems

21. The system of claim 20, wherein the secondary master delays the relay of the synchronization signal by a delay period.
